(19) United States
(12) Patent Application Publication
(10) Pub. No.: US 2026/0028516 A1
(43) Pub. Date: Jan. 29, 2026

(54) ABRASIVE PARTICLES AND POLISHING SLURRY COMPOSITION USING THE SAME

(71) Applicant: DONGJIN SEMICHEM CO., LTD., Incheon (KR)

(72) Inventors: Hye-jung PARK, Hwaseong-si (KR); Jong-chul SHIN, Hwaseong-si (KR); Sung-hoon JIN, Hwaseong-si (KR); So-ra KANG, Hwaseong-si (KR); Jong-dae PARK, Hwaseong-si (KR); Jae-hyun KIM, Hwaseong-si (KR)

(21) Appl. No.: 19/225,609

(22) Filed: Jun. 2, 2025

Related U.S. Application Data
(63) Continuation of application No. PCT/KR2023/019622, filed on Nov. 30, 2023.

(30) Foreign Application Priority Data
Dec. 29, 2022 (KR) 10-2022-0188864

(51) Int. Cl. C09K 3/14

(52) U.S. Cl. CPC C09K 3/1436; C09K 3/1463

(57) ABSTRACT

Surface-modified abrasive particles improving the polishing performance of an insulating film and a metal film and having high-temperature stability are provided. An abrasive slurry composition comprising the same is also provided. Such abrasive particles are achieved by adjusting the ratio of the content of the modifier/the content of silica, the ratio of the carbon content in the modifier/the content of silica in the slurry after centrifugation, or the isoelectric point (IEP) difference of the modified abrasive particles in the slurry before and after centrifugation to a specific range during the surface modification of the abrasive particles.

### CROSS-REFERENCE TO RELATED APPLICATIONS

This application is a Continuation of International Application No. PCT/KR2023/019622 filed Nov. 30, 2023, which claims priority from Korean Application No. 10-2022-0188864 filed Dec. 29, 2022. The aforementioned applications are incorporated herein by reference in their entireties.

### TECHNICAL FIELD

The present disclosure relates to abrasive particles suitable for polishing metal barriers in the through-silicon via (TSV) and a polishing slurry composition using the same.

### RELATED ART

In the semiconductor manufacturing process, a single chip that applies integrated circuit technology contains millions of functional elements such as transistors, capacitors, and resistors. These individual elements are interconnected by wiring designed in a specific pattern to form a circuit. With each generation of development, integrated circuits have become miniaturized, resulting in a gradual increase in the functionality of a single chip.

However, since there are limits to simply reducing the size of the device, recent research has been actively conducted on multi-layer wiring structures that form each device in multiple layers. A representative method among these is the through-silicon via (TSV) method, which involves stacking silicon wafers and the like, drilling holes, and then filling the holes with metals such as copper to form through-electrodes.

Since the TSV method is a type of packaging technology that can shorten the connection length between semiconductor packages, it is increasingly used in high-performance, ultra-small semiconductors. However, the TSV method has several technical difficulties, among which a notable issue is that the process of chemical-mechanical polishing of the filled metal requires more time compared to the conventional chemical-mechanical polishing process.

In order to solve the above-mentioned shortcomings, it is necessary to develop a chemical-mechanical polishing slurry composition that can polish at high speed by improving the polishing speed and selectivity of the insulation film to the copper film or tungsten film in the polishing slurry.

However, the slurries that have been marketed or developed to date have not yet fully satisfied all of these requirements.

### SUMMARY

It is an object of the present disclosure to provide abrasive particles improving the polishing performance of insulating films and metal films and having high-temperature stability.

It is another object of the present disclosure to provide an abrasive slurry composition to improve high-temperature stability, thus facilitating long-term storage without being affected by the ambient temperature due to the inclusion of the abrasive particles.

According to the present disclosure, there are provided abrasive particles satisfying the following Equation 1:

$$[ Equation 1 ]$$

$$( Carbon content after centrifugation / Content of the abrasive particles ) \times 10 , 000 = 2 to 285$$

In Equation 1, the carbon content after centrifugation refers to the carbon content on the surface of the abrasive particles after centrifugation of the slurry including the surface-modified abrasive particles, which is measured using a carbon analyzer based on the total weight of the abrasive particle solids obtained after centrifuging the slurry including surface-modified abrasive particles for 10 minutes, and the content of the abrasive particles is the content of surface-modified abrasive particles included in the slurry.

In addition, there is provided a polishing slurry composition comprising the abrasive particles and a solvent.

Hereinafter, embodiments of the present disclosure will be described in more detail. It will be understood that words or terms used in the specification and the appended claims shall not be limited to the meaning defined in commonly used dictionaries. It will be further understood that the words or terms should also be interpreted as having a meaning that is consistent with their meaning in the context of the relevant art and the technical idea of the invention, based on the principle that an inventor may properly define the meaning of the words or terms to best explain the invention.

In addition, the term “including” or “comprising” as used herein specifies a specific feature, region, integer, step, action, element and/or component, but does not exclude the presence or addition of a different specific feature, region, integer, step, action, element, and/or component.

Hereinafter, the abrasive particles according to an embodiment of the present disclosure and the polishing slurry composition including them will be described in more detail.

The present disclosure provides centrifuging after modifying the surface of the abrasive particles, and then adjusting the ratio of carbon content of abrasive particles to the content of abrasive particles to a specific range, thereby providing surface-modified abrasive particles and a polishing slurry composition including the same to improve the polishing performance of insulating and metal films and to have high-temperature stability.

The abrasive particles according to the present disclosure are not particularly limited, but may include, for example, silica, ceria, alumina, zirconia, or the like. The abrasive particles may refer to surface-modified abrasive particles, specifically, abrasive particles whose surfaces are modified by a modifier. When surface-modified abrasive particles are used in the present disclosure, it is possible to improve the polishing speed of the insulating film compared to the metal film, thereby increasing the selectivity between the metal film and the insulating film while reducing dishing.

According to an embodiment of the present disclosure, abrasive particles may be configured to satisfy the following Equation 1.

$$[ Equation 1 ]$$

$$( Carbon content after centrifugation / Content of the abrasive particles ) \times 10 , 000 = 2 to 285$$

As an alternative expression, 2≤(Carbon content after centrifugation/Content of the abrasive particles)×10,000≤285.

In Equation 1, the carbon content after centrifugation refers to the carbon content on the surface of the abrasive particles after centrifugation of the slurry including the surface-modified abrasive particles, which is measured using a carbon analyzer based on the total weight of the abrasive particle solids obtained after centrifuging the slurry including surface-modified abrasive particles for 10 minutes, and the abrasive particle content is the content of surface-modified abrasive particles included in the slurry.

The carbon analyzer may be, for example, the ELEMENTRAC CS-d, commercially available from ELTRA.

The value of Equation 1 may be, for example, 2 to 285, 5 to 280, 15 to 280, 5 to 200, 10 to 150, or 200 to 285. If the value of Equation 1 is less than 2, polishing performance may not be improved due to the low content of the modifier compared to abrasive particles. If it exceeds 285, defects may increase as the particle size stability decreases at high temperatures.

In Equation 1, the carbon content after centrifugation of the abrasive particles may be the carbon content contained within the abrasive particles measured by the following method: in which a process is conducted 5 to 10 times, which includes centrifuging the abrasive slurry including surface-modified abrasive particles, removing the supernatant, replenishing with deionized water (DIW), dispersing the precipitate using ultrasonication for 1 hour. Subsequently, the precipitated particles are dried and collected as a powder. Then, the carbon content contained within the abrasive particles is measured using a carbon analyzer (ELTRA ELEMENTRAC CS-d).

More specifically, the carbon content after centrifugation may be the carbon content included on the surfaces of the above abrasive particles after centrifugation of the slurry, based on the total weight (100% by weight) of the abrasive particle solids obtained by the centrifugation after surface modification. In other words, it may be the carbon content (% by weight) of the surface modifier bound to the above abrasive particles.

The centrifugation may be performed under conditions of 20,000 rpm for 10 to 30 minutes at 4° C., and the first centrifugation may be performed for 30 minutes.

According to another embodiment of the present disclosure, the abrasive particles may be abrasive particles satisfying the following Equation 2.

$$[ Equation 2 ]$$

$$( Content of the modifier / Content of the abrasive particles ) \times 10 , 000 = 10 to 1 , 240$$

As an alternative expression, 10≤(Content of the modifier/Content of the abrasive particles)×10,000≤1,240.

In Equation 2, the content of the modifier may be the amount of modifier added during the production of surface-modified abrasive particles, or the amount of modifier present on the surface of the abrasive particles after surface modification. The abrasive particles may be the amount of surface-modified abrasive particles included in the slurry, which includes the surface-modified abrasive particles. The amount of modifier present on the surface of the abrasive particles after surface modification may be the amount of modifier, which is measured based on 100% by weight of the abrasive particle solids obtained after centrifuging the slurry including the surface-modified abrasive particles.

At this time, in the present disclosure, the content of the modifier present on the surface of the abrasive particles after surface modification may refer to the carbon content bound to the surface of the abrasive particles, which is obtained by centrifuging the slurry including the surface-modified abrasive particles for 10 minutes and then drying the abrasive particles. Therefore, the content of the modifier may include the carbon content after centrifugation as per Equation 1. The carbon content may be measured using a carbon analyzer.

In Equation 2, the abrasive particles may be abrasive particles whose surfaces have been modified by a modifier. Therefore, the content of the abrasive particles is the content of the surface-modified abrasive particles included in the slurry, similar to Equation 1.

In the present disclosure, the abrasive particle solids obtained after centrifugation may be dried solids, and the drying temperature is not limited to a particular temperature. For example, the abrasive particle solids may be dried at a temperature of about 30 to 60° C.

The values for Equation 2 may be 10 to 1,240, 20 to 1,218, 64 to 1,218, 20 to 870, 45 to 650, or 500 to 1,240. Since it is possible to achieve excellent particle size stability at high temperature while also having excellent polishing performance within the value range of Equation 2, defects may not occur.

The modifier may include, for example, in an amount of 0.0001 to 5 parts by weight, or 0.0004 to 3.72 parts by weight, or 0.0006 to 2.7 parts by weight, relative to 100 parts by weight of the abrasive particles.

If the content of the modifier is within the above range, the modification of the abrasive particles may be sufficient, resulting in high polishing performance while not deteriorating particle size stability at high temperature.

According to another embodiment of the present disclosure, the difference in the isoelectric point (IEP) of the abrasive particles before and after centrifugation may be 1 or less, or 0.1 to 1 or less, or 0.1 to 0.8.

A change in IEP values of 1 or more before and after centrifugation indicates that the surface of the abrasive particles has not been modified or has been only weakly modified. This means that the unmodified modifier on the surface of the abrasive particles has been removed by being included in the supernatant through centrifugation.

The abrasive particles of the present disclosure improve particle dispersion compared to conventional ones, resulting in a polishing speed of the insulating film that is faster than that of the metal film, so that selectivity may be increased and dishing may be reduced.

According to an embodiment, the difference in the isoelectric point (IEP) before and after the centrifugation may be measured according to the following Equation 3.

$$[ Equation 3 ]$$

$$Difference in isoelectric point ( IEP ) before after centrifugation = Isoelectric point ( IEP ) after centrifugation - Isoelectric point ( IEP ) before centrifugation$$

The isoelectric point before centrifugation refers to determining the pH at which the zeta potential becomes zero by adjusting the pH to at least 3 (for example, pH 3, 4.5, or 10) using nitric acid and KOH after preparing a polishing slurry composition including abrasive particles, and then plotting the measured zeta potential values on a graph. The zeta potential may be the average value obtained from five repeated measurements using a zeta potential analyzer, which may be, for example, the Litesizer500 from Anton Paar.

According to one embodiment, the isoelectric point after centrifugation may be measured and determined by the following method.

After performing centrifugation on the abrasive slurry composition including the abrasive particles, the supernatant is removed and replenished with deionized water (DIW), after which the precipitate is then dispersed using ultrasonication for 1 hour. These processes are repeated five times. Subsequently, the resulting product is centrifuged, and the pH is adjusted to the same pH as before centrifugation using nitric acid and KOH. Finally, the zeta potential is measured and graphed to determine the pH at which the zeta potential is zero.

The abrasive particles according to an embodiment of the present disclosure may effectively modify the surface of the abrasive particles by adjusting the isoelectric point difference to 1 or less before and after centrifugation. Therefore, it may improve the polishing performance while ensuring particle size stability at high temperatures, thereby manifesting an effect of improved defects.

The abrasive particles may satisfy a nitrogen in an amount of 0.00001 to 0.5% by weight, or 0.00004 to 0.4% by weight, measured using a nitrogen analyzer (ELTRA ONH-p) based on 100% by weight of the abrasive particles obtained after centrifuging a slurry including surface-modified abrasive particles. When the nitrogen content included in the abrasive particles satisfies the aforementioned range, the abrasive performance becomes excellent, and the particle size stability at high temperatures becomes superior, thereby preventing defects from occurring.

The nitrogen analyzer is not particularly limited, but for example, it may be the ELTRA ONH-p.

The surface modification target to provide the surface-modified abrasive particles may be used alone or in combination with colloidal silica, fumed silica, alumina, ceria, titania, zirconia, or the like, but specifically, it may be colloidal silica or fumed silica.

The abrasive particles may have a specific surface area of less than 175 m²/g measured by the Brunauer-Emmett-Teller (BET) analysis, for example, and specifically, 20 to 170 m²/g, 20 to 150 m²/g, 55 to 170 m²/g, or 55 to 100 m²/g. If the value of the abrasive particles by the BET is 175 m²/g or greater, issues such as an increased pH and particle size at room temperature may arise, leading to decreased storage stability and inconsistent polishing speed.

As a specific example, the specific surface area by the BET analysis may be the value by the BET of the abrasive particles before surface modification or the value by the BET of the surface-modified abrasive particles.

The modifier may be an organosilane of one or more selected from the group consisting of, for example, 3-aminopropyltriethoxysilane (APTES), 3-aminopropyltrimethoxysilane (APTMS), N-2-(Aminoethyl)-3-aminopropylmethyldimethoxysilane, N-2-(Aminoethyl)-3-aminopropyltrimethoxysilane, 3-aminopropyltriethoxysilane, 3-aminopropyltrimethoxysilane, 3-triethoxysilyl-N-(1,3-dimethyl-butylidene) propylamine, N-Phenyl-3-aminopropyltrimethoxysilane, and n-(vinylbenzyl)-2-aminoethyl-3-aminopropyltrimethoxysilane hydrochloride. Specifically, the modifier may be APTES or APTMS, and when using the modifying agent, it facilitates the modification of abrasive particles and offers economic advantages.

As a preferred example, the abrasive particles may be silica that is surface-modified with APTES.

According to an embodiment of the present disclosure, there may be provided a polishing slurry composition including abrasive particles satisfying the above Equation 1 and a solvent.

The abrasive particles may comprise in an amount of 0.01 to 30% by weight, 0.5 to 25% by weight, or 1 to 20% by weight of the total weight of the abrasive slurry composition. When the content of the abrasive particles is within these ranges, a ratio of the polishing speed of the insulating film to the metal film may satisfy 1:1 or greater.

The solvent may include water and may be included as the remainder in the polishing slurry composition, excluding the abrasive particles. In addition, if stabilizers, oxidizers, pH adjusters, etc., which will be described later, are further included in the polishing slurry composition, the solvent may be included as the remaining component, excluding these components. The water, for example, may be deionized water.

The polishing slurry composition may further include an organic acid. It can stabilize the electrical double layer on the surface of modified polishing particles due to incorporating the organic acid, thereby enhancing storage stability in acidic conditions.

The organic acid may be included in an amount of 0.005 to 0.5% by weight, or 0.1 to 1% by weight, based on the total weight of the polishing slurry composition. Within these ranges, it has the effect of stabilizing the electrical double layer on the surface of the modified polishing particles, thereby improving storage stability in acidic conditions.

The organic acid may be one or more selected from the group consisting of formic acid (HCOOH), acetic acid (CH₃COOH), propionic acid (CH₃CH₂COOH), oxalic acid, citric acid, malic acid (HO₂CCH₂CH(OH)CO₂H), malonic acid (CH₂(COOH)₂), sulfonic acid, and tartaric acid (HOOCCH(OH)CH(OH)COOH).

The polishing slurry composition may further include an oxidizing agent.

The oxidizing agent is intended to rapidly convert a metal film into a metal oxide film to facilitate the polishing of copper or tungsten films, and any conventional oxidizing agent used in chemical-mechanical polishing slurry compositions may be used without particular limitation. For example, the oxidizing agent may be an inorganic or organic per-compound. The per-compound refers to a compound containing one or more peroxy groups (—O—O—) or a compound containing an element in its highest oxidation state. Specific examples of the oxidizing agent include hydrogen peroxide, urea hydrogen peroxide, monopersulfate, dipersulfate, peracetic acid, percarbonate, benzoyl peroxide, periodic acid, periodate salts, perbromic acid, perboric acid, perborate, perchloric acid, perchlorate, permanganate, and permanganate salts and the like, and these may be used alone or in combination.

The oxidizing agent may be included in an amount of 0.01 to 5% by weight based on the total weight of the polishing slurry composition.

The polishing slurry composition may have a zeta potential of 3 to 50 mV, 5 to 48 mV, 7 to 48 mV, or 10 to 48 mV. Within these ranges, the polishing speed of the insulating film to the metal film may be 1:1 or higher.

The polishing slurry composition may further include one or more of a catalyst, a biocide, a pH adjuster, a corrosion inhibitor, a defect improver, or a pad protector.

The catalyst may include iron nitrate, iron chloride, iron sulfate, and ferrosilicon. The catalyst may be included in an amount of 0.00002 to 0.07% by weight based on the total weight of the polishing slurry composition.

The biocide prevents the CMP polishing slurry composition from being contaminated by microorganisms such as bacteria and fungi, and its type is not particularly limited.

Specifically, the biocide (disinfectant) may use isothiazolinone or its derivatives, for example, may be used methylisothiazolinone (MIT, MI), chloromethyl isothiazolinone (CMIT, CMI, MCI), benzisothiazolinone (BIT), octylisothiazolinone (OIT, OI), dichlorooctylisothiazolinone (DCOIT, DCOI), butylbenzisothiazolinone (BBIT) and the like.

The content of the biocide may be included in an amount of 0.0001% to 0.1% by weight based on the total weight of the polishing slurry composition. When the content of the biocide is within this range, there is a microbial inhibition effect while the dispersibility of the slurry composition is excellent.

The pH adjusting agent may be one or more selected from the group consisting of nitric acid, hydrochloric acid, phosphoric acid, malonic acid, quaternary ammonium compounds, and potassium hydroxide.

The pH adjusting agent may be included in an amount of 0.0001% to 1% by weight based on the total weight of the polishing slurry composition. Due to the use of the pH adjusting agent, the pH of the polishing slurry composition may be adjusted to 2 to 5.

The corrosion inhibitor may use conventional materials to prevent the corrosion of the metal film. For example, the corrosion inhibitor may include 1,2,4-Triazole, 1H-benzotriazole and the like, and is not limited to these types. The corrosion inhibitor may be included in an amount of 0.01 to 5% by weight or 0.001 to 1% by weight relative to the total weight of the polishing slurry composition.

The defect improver may use lysine, picolinic acid, or the like, and its content may be included in an amount of 0.01 to 5% by weight or 0.001 to 1% by weight based on the total weight of the polishing slurry composition.

The pad protector may be one or more selected from the group consisting of polysaccharides, cellulose, sucrose, and xylitol.

The content of the pad protector may be included in an amount of 0.0001 to 1% by weight relative to the total weight of the polishing slurry composition.

The polishing slurry composition according to the present disclosure comprises abrasive particles satisfying Equation 1 and uses them for polishing insulating films (such as SiO₂, organic films) and metal films (such as Cu, W), so that it may improve the polishing selectivity and may exhibit high-temperature stability, thereby enhancing storage stability.

Specifically, the polishing slurry composition has a polishing speed of 1,800 Å/min or less for a copper film and a polishing speed of 1,400 Å/min or more for a silicon oxide film, and may be used in the through-silicon via (TSV) method. In addition, the polishing slurry composition may have the ratio of the polishing speed of a metal film to the polishing speed of an insulation film of 1:1 or more, 1:1.5 or more, 1:3 or more, 1:1 to 1:11, or 1:1.1 to 1:10. For example, the polishing composition may have the polishing selectivity of the copper film to the insulation film of 1:1 or more, 1:1.5 or more, 1:3 or more, 1:1 to 1:11, or 1:1.1 to 1:10.

According to the present disclosure, there may be provided abrasive particles in which the carbon content within the abrasive particles obtained after centrifugation of the abrasive slurry composition satisfies a specific value relative to the content of the abrasive particles.

In addition, the present disclosure may provide abrasive particles in which the modification reaction is effectively performed by adjusting the IEP difference of the abrasive particles before and after centrifugation to a specific range during surface modification.

Further, the polishing slurry composition including the abrasive particles may improve the polishing performance of the insulating film and the metal film, and particularly have high-temperature stability at 50° C. or more.

Furthermore, the polishing slurry composition may be usefully employed in the TSV (Through Silicon Via) method, significantly improving polishing performance.

### DETAILED DESCRIPTION

Hereinafter, Examples of the present disclosure will be described for better understanding. However, the following Examples are given for illustrative purposes only, and are not intended to limit the present disclosure.

### EXAMPLES, COMPARATIVE EXAMPLES AND REFERENCE EXAMPLES

### Experimental Conditions and Measurement Equipment

CMP (Chemical Mechanical Polishing) and evaluation were conducted under the following conditions for the polishing slurry compositions of each example, comparative examples, and reference examples.
1. Experimental Wafer: Insulating film (PE-TEOS) 10-inch blanket wafer, metal film (Cu) 10-inch blanket wafer, Cu Pattern 10-inch wafer (Product name SKW 6-3)
2. Polishing Equipment: AP300 (CST Company)
3. Grinding conditions: see Table 1

TABLE 1

| | | | | | | | Flow rate of |
|---|---|---|---|---|---|---|---|
| Rotation speed (rpm) | | Pressure (psi) | | | | | polishing slurry |
| Platen | Head | Z1 | Z2 | Z3 | Z4 | Z5 | (ml/min) |
| 103 | 97 | 3.0 | 3.0 | 3.0 | 3.0 | 3.0 | 300 |

4. Polishing Pad: IC-1010 (by Dupont)
5. Thickness (Polishing Speed) Measurement Equipment
Metal film: CMT-SR5000 (AIT Co.)
Insulating film: ST-5000 (K-MAC Co.)
Polishing speed=Thickness before polishing-Thickness after polishing
6. Particle size and zeta potential analysis equipment
Litesizer (Anton Paar Co.)
7. Defect Analysis
Surfscan SP2 (KLA Tencor Inc.)
8. Carbon content analysis
Test Equipment: ELEMENTRAC CS-d (ELTRA Company)
Detector: IR Cell
   a. Method for Measuring Carbon Content after Centrifugation

After pre-treating the sample for carbon content analysis using the following method, the carbon content was measured after centrifugation.
\textcircled{1} Centrifugation of the polishing slurry was performed at 4° C. and 20,000 rpm for 10 minutes (with the initial instance conducted for 30 minutes), after which the supernatant was removed and deionized water (DIW) was replenished.
\textcircled{2} The precipitate was dispersed using ultrasonication for 1 hour, and this process was repeated a total of 5 times as described above.
\textcircled{3} The precipitated particles were dried and collected as a powder, and then a quantitative carbon analysis was performed using a carbon analyzer (ELTRA ELEMENTRAC CS-d).
9. Centrifugation conditions and measurement method of samples before and after centrifugation to measure the difference in the isoelectric point (IEP) a. Sample before centrifugation
\textcircled{1} The pH of the polishing slurry was adjusted to 3, 4.5, and 10 using nitric acid and KOH, respectively.
\textcircled{2} The zeta potential was measured for the sample with the adjusted pH.
   b. Sample after Centrifugation
\textcircled{1} Centrifugation of the polishing slurry was performed under conditions of 20,000 rpm for 10 minutes at 4° C. (with the initial instance conducted for 30 minutes), after which the supernatant was removed and deionized water (DIW) was replenished.
\textcircled{2} Thereafter, precipitate was dispersed using ultrasonication for 1 hour, and this process was repeated a total of 5 times as described above.
\textcircled{3} Finally, after centrifugation, the pH was adjusted to 3, 4.5, and 10 using nitric acid and KOH, respectively, to match the pH levels prior to centrifugation.
\textcircled{4} The Zeta potential of the pH-adjusted sample was measured.
   c. Difference in the Isoelectric Point (IEP) Before and After Centrifugation (IEP Change Value)

The difference in the isoelectric point (IEP) before and after the centrifugation may be measured according to the following Equation 3.

$$[ Equation 3 ]$$

$$Difference in the isoelectric point ( IEP ) before after centrifugation = Isoelectric point ( IEP ) after centrifugation - Isoelectric point ( IEP ) before centrifugation$$

### Manufacture of Polishing Slurry 1: Example 1 to 5 and Reference Examples 1 and 2

In order to use silica with a surface modified by the organosilane in the polishing slurry, the modification of silica was performed according to the BET, as illustrated in Table 2.

Silica, APTES (surface modifier), and acetic acid were mixed with distilled water in the amounts shown in Table 2, and stirred with a mechanical stirrer for a predetermined period of time to prepare a polishing slurry. Additionally, the pH was adjusted to 3.5 using the pH adjusting agent

### Experimental Example 1

### Evaluation of pH and Particle Size Stability of Silica Particles According to the BET

For Examples 1 to 5 and Reference Examples 1 and 2, the pH and particle size stability of the silica particles were evaluated according to the BET, and the results are shown in Table 2.

The results of comparing the pH and particle size stability of silica according to the BET at room temperature (23° C.) are shown in Table 2 below. In Table 2, the silica % by weight represents the weight percentage of silica, calculated based on the total weight percentage of the polishing slurry composition.

In addition, according to the method for measuring carbon content after centrifugation described above in item 8, the values of the abrasive particles after centrifugation were measured using equations 1 and 2, and the results are shown in Table 2.

Specifically, a content ratio of the carbon content after centrifugation/the abrasive particles was calculated according to the following Equation 1.

$$[ Equation 1 ]$$

$$( Carbon content after centrifugation / Content of the abrasive particles ) \times 10 , 000$$

In Equation 1, the carbon content after centrifugation is the carbon content on the surface of the abrasive particles measured using a carbon analyzer, based on the total weight of the abrasive particle solids obtained after centrifuging the slurry including surface-modified abrasive particles for 10 minutes. The content of the abrasive particles is the content of the surface-modified abrasive particles included in the slurry above.

Furthermore, the ratio of the content of the modifier to the content of the abrasive particles was calculated according to the following Equation 2a.

$$[ Equation 2 a ]$$

$$( Content of the modifier / Content of the abrasive particles ) \times 10 , 000$$

In Equation 2a, the content of the modifier refers to the amount of modifier added during the production of surface-modified abrasive particles, and the content of the abrasive particles is the amount of surface-modified abrasive particles included in the slurry above.

In addition, according to the centrifugation conditions and measurement methods of the sample before and after the centrifugation described above in item 9, the difference in the isoelectric point of the polishing particles before and after centrifugation (hereinafter referred to as IEP difference) was measured and the results are shown in Table 2.

TABLE 2

| | | | | | | | | Manufacture | | 23° C., 1 day | |
|---|---|---|---|---|---|---|---|---|---|---|---|
| | Silica | | | Acetic | Equa- | Equa- | Differ- | date | | elapsed | |
| | | BET | APTES | acid | tion | tion | ences | | Particle | | Particle |
| No. | wt % | (m²/g) | (wt %) | (wt %) | 1 | 2 | in IEP | pH | size | pH | size |
| Reference | 10 | 250 | 0.004 | 0.05 | 9.2 | 40.0 | 0.72 | 3.0 | 12 | 4.2 | 46 |
| example 1 | | | | | | | | | | | |
| Reference | 10 | 175 | 0.004 | 0.05 | 9.2 | 40.0 | 0.8 | 3.0 | 18 | 3.8 | 40 |
| example 2 | | | | | | | | | | | |
| Example 1 | 10 | 150 | 0.004 | 0.05 | 9.2 | 40.0 | 0.55 | 3.0 | 21 | 3.0 | 21 |
| Example 2 | 10 | 80 | 0.004 | 0.05 | 9.2 | 40.0 | 0.64 | 3.0 | 46 | 3.0 | 46 |
| Example 3 | 10 | 55 | 0.004 | 0.05 | 9.2 | 40.0 | 0.70 | 3.0 | 52 | 3.0 | 52 |
| Example 4 | 10 | 30 | 0.004 | 0.05 | 9.2 | 40.0 | 0.63 | 3.0 | 123 | 3.0 | 123 |
| Example 5 | 10 | 20 | 0.004 | 0.05 | 9.2 | 40.0 | 0.58 | 3.0 | 142 | 3.0 | 142 |

According to Table 2, it was confirmed that storage stability of Examples 1 to 5, where the BET value of silica was less than 175 m²/g, was superior to Reference Examples 1 and 2, which had a BET value of 175 m²/g or greater, as there were no changes in pH and particle size of the abrasive particles after one day at room temperature (23° C.).

### Manufacture of Polishing Slurry 2: Examples 6 to 12 and Comparative Examples 1 to 6

Silica, APTES (surface modifier), and acetic acid were mixed with distilled water (residual amount) in the amounts shown in Table 2, and stirred with a mechanical stirrer for a predetermined period of time to prepare a polishing slurry. At this time, Comparative Examples 1 to 5 and Examples 6 to 12 were stirred for 24 hours, and Comparative Example 6 was stirred for 5 minutes. Additionally, the pH was adjusted to 3.5 using the pH adjusting agent.

Subsequently, a polishing slurry composition was prepared by mixing hydrogen peroxide before performing polishing on the polishing pad.

TABLE 3

| | | | | Acetic | Hydrogen |
|---|---|---|---|---|---|
| | Silica | BET | APTES | acid | Peroxide |
| No. | (wt %) | (m2/g) | (wt %) | (wt %) | (wt %) |
| Comparative | 16 | 80 | 0 | 0.08 | 0.05 |
| Example 1 | | | | | |
| Comparative | 16 | 80 | 0.001 | 0.08 | 0.05 |
| Example 2 | | | | | |
| Example 6 | 16 | 80 | 0.0025 | 0.08 | 0.05 |
| Example 7 | 16 | 80 | 0.02 | 0.08 | 0.05 |
| Example 8 | 16 | 80 | 0.05 | 0.08 | 0.05 |
| Example 9 | 16 | 80 | 0.1 | 0.08 | 0.05 |
| Example 10 | 16 | 80 | 0.3 | 0.08 | 0.05 |
| Comparative | 16 | 80 | 0.32 | 0.08 | 0.05 |
| Example 3 | | | | | |
| Comparative | 16 | 80 | 0.43 | 0.08 | 0.05 |
| Example 4 | | | | | |
| Example 5 | 16 | 80 | 0.001 | 0.08 | 0.05 |
| Example 11 | 5 | 80 | 0.031 | 0.03 | 0.05 |
| Example 12 | 2 | 80 | 0.0048 | 0.03 | 0.05 |
| Comparative | 16 | 80 | 0.02 | 0.08 | 0.05 |
| Example 6 | | | | | |

### Experimental Example 2

For Examples 6 to 12 and Comparative Examples 1 to 6, CMP (Chemical Mechanical Polishing) evaluation was conducted using the aforementioned method, and the results are shown in Table 4.

TABLE 4

| | | | | Change in IEP | | | SiO2 | | |
|---|---|---|---|---|---|---|---|---|---|
| | | | | value (after | | | polishing | | |
| | | | | centrifuga- | Cu | SiO2 | speed/Cu | | |
| | | | | tion − before | polishing | polishing | polishing | | SiO2 |
| | Equa- | Equa- | Zeta- | centrifu- | speed | speed | speed, | Dishing | Defect |
| No. | tion1 | tion2 | potential | gation) | (Å/min) | (Å/min) | Selectivity | (Å) | (ea) |
| Comparative | 0 | 0 | −1 | 0.06 | 1,834 | 1,432 | 0.8 | 480 | 2,500 |
| Example 1 | | | | (3.34-3.40) | | | | | |
| Comparative | | 4 | 2 | 1.12 | 1,827 | 1,688 | 0.9 | 470 | 2,477 |
| Example 2 | | | | (4.45-3.33) | | | | | |
| Example 6 | 2 | 10 | 3 | 1.00 | 1,766 | 1,893 | 1.1 | 295 | 1,530 |
| | | | | (4.52-3.52) | | | | | |
| Example 7 | 18 | 78 | 11 | 0.72 | 1,856 | 2,227 | 1.2 | 230 | 1,200 |
| | | | | (5.20-4.48) | | | | | |
| Example 8 | 45 | 195 | 15 | 0.29 | 1,788 | 2,606 | 1.5 | 230 | 1,196 |
| | | | | (5.12-5.41) | | | | | |
| Example 9 | 90 | 391 | 32 | 0.38 | 1,868 | 3,730 | 2.0 | 220 | 1,211 |
| | | | | (5.72-5.34) | | | | | |
| Example 10 | 270 | 1172 | 48 | 0.25 | 1,832 | 5,314 | 2.9 | 219 | 917 |
| | | | | (5.43-5.68) | | | | | |
| Comparative | 288 | 1250 | 47 | 0.41 | 1,847 | 4,805 | 2.6 | 223 | 4,633 |
| Example 3 | | | | (5.55-5.14) | | | | | |
| Comparative | 386 | 1680 | 44 | 0.62 | 1,799 | 4,142 | 2.3 | 234 | 5,337 |
| Example 4 | | | | (5.01-5.63) | | | | | |
| Example 5 | 1 | 4 | 2 | 1.10 | 1,811 | 1,505 | 0.8 | 494 | 4,570 |
| | | | | (4.40-3.30) | | | | | |
| Example 11 | 285 | 1240 | 13 | 0.21 | 346 | 1,402 | 4.1 | 195 | 1,713 |
| | | | | (5.43-5.64) | | | | | |
| Example 12 | 276 | 1200 | 24 | 0.32 | 141 | 1,411 | 10.0 | 177 | 1,052 |
| | | | | (5.47-5.15) | | | | | |
| Comparative | 1 | 78 | −1 | 1.05 | 1,818 | 1,455 | 0.8 | 492 | 2,356 |
| Example 6 | | | | (4.25-3.20) | | | | | |

Note)
The change in IEP values of 1 or more before and after centrifugation indicates that the silica surface has been weakly modified, or that the unmodified modifier on the silica surface has been included in the supernatant through centrifugation and was thereafter removed by washing.

According to Table 4, Examples 6 to 12 satisfied the value of Equation 1 ranging from 2 to 285.

Conversely, Comparative Examples 1, 2, 5, and 6, with values of Equation 1 less than 2, showed slower polishing speeds for the insulating film (SiO₂). Thus, they not only failed to meet the selectivity criteria between the insulating film (SiO₂) and the metal film (Cu) as intended by the present disclosure, but also resulted in significantly increased defects such as dishing and defects in the insulating film (SiO₂).

In addition, it was confirmed that Comparative Examples 3 and 4, where the value of Equation 1 exceeded 285, also showed a considerable increase in defects in the insulating film.

Furthermore, it was confirmed that Examples 6 to 12 satisfied the value of Equation 2, ranging from 10 to 1,240, and it was verified that both dishing and insulation defects were reduced by satisfying this value range of Equation 2.

### Manufacture of Polishing Slurry 3: Examples 13 to 15 and Comparative Examples 7 to 9

Silica (80 m²/g by the BET), APTES, and acetic acid were mixed with distilled water in the amounts shown in Table 5, and stirred using a mechanical stirrer for a predetermined period to prepare a polishing slurry. Additionally, the pH was adjusted to 3.5 using the pH adjusting agent.

### Experimental Example 3

### Particle Size Stability Evaluation at 50° C.

For Examples 13 to 15 and Comparative Examples 7 to 9, CMP (Chemical Mechanical Polishing) evaluation was conducted using the aforementioned method, and the results are shown in Table 5.

In addition, the particle size stability for 4 weeks at 50° C. was compared, and the results are shown in Table 5.

TABLE 5

| | | | (wt %) | | | | | |
|---|---|---|---|---|---|---|---|---|
| | | | Acetic | | | | | |
| | Silica | APTES | acid | | | Differences | Date of | 50° C., |
| No. | (wt %) | (wt %) | (wt %) | Equation 1 | Equation 2 | in IEP | manufacture | 4 weeks |
| Comparative | 10 | 0 | 0.07 | 0 | 0 | 0.13 | 55 | Cohesion/ |
| Example 7 | | | | | | | | Unmeasurable |
| Comparative | 10 | 0.0006 | 0.07 | 1 | 6 | 1.31 | 55 | 89 |
| Example 8 | | | | | | | | |
| Example 13 | 10 | 0.0015 | 0.07 | 3 | 15 | 0.92 | 55 | 55 |
| Example 14 | 10 | 0.05 | 0.07 | 115 | 500 | 0.55 | 55 | 54 |
| Example 15 | 10 | 0.08 | 0.07 | 184 | 800 | 0.64 | 55 | 55 |
| Comparative | 10 | 0.128 | 0.07 | 294 | 1280 | 0.48 | 55 | 62 |
| Example 9 | | | | | | | | |

The purpose of the particle stability Evaluation at 50° C. is to verify whether particles agglomerate at temperatures (at 40 to 60° C.) generated by friction between the pad and the wafer during polishing, which is one of the causes of defects.

According to Table 5, in the case of Examples 13 to 15, when Equations 1 and 2 were satisfied, it was confirmed that particle size stability was maintained at high temperatures of 50° C. or more for 4 weeks, compared to Comparative Examples 7 to 9, which did not satisfy these conditions. In addition, this effect may support the results of reduced defects in Table 4.

What is claimed is:

1. Abrasive particles, which satisfy the following Equation 1:
$$[ Equation l ]$$
$$( Carbon content after centrifugation / Content of the abrasive particles ) \times 10 , 000 = 2 to 285 ,$$
wherein the carbon content after centrifugation refers to a carbon concentration on the abrasive particles after centrifugation of a slurry including surface-modified abrasive particles, which is measured using a carbon analyzer based on 100% by weight of abrasive particle solids resulting from the centrifugation of the slurry including the surface-modified abrasive particles.

2. The abrasive particles according to claim 1, wherein surfaces of the abrasive particles are modified by a modifier.

3. The abrasive particles according to claim 2, wherein the abrasive particle satisfies the following Equation 2:
$$[ Equation 2 ]$$
$$( Content of the modifier / Content of the abrasive particles ) \times 10 , 000 = 10 to 1 , 240.$$

4. The abrasive particles according to claim 1, wherein the abrasive particles have an isoelectric point (IEP) difference of 1 or less before and after centrifugation.

5. The abrasive particles according to claim 1, wherein the abrasive particles have a specific surface area of less than 175 m²/g when measured by a Brunauer-Emmett-Teller (BET) analysis.

6. The abrasive particles according to claim 5, wherein the abrasive particles have the specific surface area of 20 to 170 m²/g measured by the BET analysis.

7. The abrasive particles according to claim 2, wherein the modifier is an organosilane of one or more selected from the group consisting of 3-aminopropyltriethoxysilane (APTES), 3-aminopropyltrimethoxysilane (APTMS), N-2-(aminoethyl)-3-aminopropylmethyldimethoxysilane, N-2-(aminoethyl)-3-aminopropyltrimethoxysilane, 3-aminopropyltriethoxysilane, 3-aminopropyltrimethoxysilane, 3-triethoxysilyl-N-(1,3-dimethyl-butylidene)propylamine, N-phenyl-3-aminopropyltrimethoxysilane, and n-(vinylbenzyl)-2-aminoethyl-3-aminopropyltrimethoxysilane hydrochloride.

8. The abrasive particles according to claim 1, wherein the abrasive particles include nitrogen in an amount of 0.00001 to 0.5% by weight, measured using a nitrogen analyzer based on 100% by weight of the abrasive particle solids obtained after centrifuging the slurry including surface-modified abrasive particles.

9. A polishing slurry composition comprising the abrasive particles of claim 1 and a solvent.

10. The polishing slurry composition according to claim 9, wherein the abrasive particles are included in an amount of 0.01 to 30% by weight with respect to the total weight of the polishing slurry composition.

11. The polishing slurry composition according to claim 9, which has a zeta potential of 3 to 50 mV.

12. The polishing slurry composition according to claim 9, wherein the polishing slurry composition further includes an organic acid.

13. The polishing slurry composition according to claim 9, wherein the polishing slurry composition further includes an oxidizing agent.

14. The polishing slurry composition according to claim 9, wherein the polishing slurry composition further includes one or more of a catalyst, a biocide, a pH adjuster, a corrosion inhibitor, a defect improver, or a pad protector.
